(19) United States
(12) Patent Application Publication
(10) Pub. No.: US 2016/0252758 A1
(43) Pub. Date: Sep. 1, 2016

(54) SECURE TRANSPARENT DISPLAY

(71) Applicant: EMPIRE TECHNOLOGY DEVELOPMENT LLC, Wilmington, DE (US)

(72) Inventor: Hyoung-Gon LEE, Gapyeong-gu, Gyeonggi-do (KR)

(73) Assignee: Empire Technology Development LLC, Wilmington, DE (US)

(21) Appl. No.: 15/026,606

(22) PCT Filed: Nov. 21, 2013
(86) PCT No.: PCT/US2013/071311

§ 371 Date: Apr. 1, 2016

(51) Int. Cl. G02F 1/13; G02F 1/133; G01B 5/24; G02F 1/1335; H04N 5/232; G01C 9/02; G02F 1/01; G02F 1/1337

(52) U.S. Cl. CPC G02F 1/1323; G02F 1/0136; G02F 1/13318; G02F 1/1337; G02F 1/133528; H04N 5/23229; G01C 9/02; G01B 5/24; G02F 2001/133773

(57) ABSTRACT

A system has a first lens including a first polarization filter and a light polarization layer, a second lens including a second polarization filter and a polarization angle control module coupled to the first lens. The polarization angle control module operatively enables determination of an angle of polarization of the second polarization filter and adjusts an angle of polarization of the light polarization layer such that an image may be viewed when looking through the first lens and the second lens.

### BACKGROUND

Unless otherwise indicated herein, the approaches described in this section are not prior art to the claims in this application and are not admitted to be prior art by inclusion in this section.

Current transparent head-up displays present text/images on a transparent medium wherein the displayed images may be visible on either side of the transparent medium. Because the images are visible from both sides of the transparent medium, such visibility may be inconvenient to a user who is using a head-up display to view confidential, private, personal, or other types of text/images.

### SUMMARY

According to sonic examples, a system comprising, a first lens including a first polarization filter and a light polarization layer, a second lens including a second polarization filter and a polarization angle control module coupled to the first lens. The polarization angle control module may he operatively enabled to determine an angle of polarization of the second polarization filter and adjust an angle of polarization of the light polarization layer based at least in part on the determined angle of polarization of the second polarization filter to enable an image to be viewed through the first lens and the second lens.

According to some examples, a method to display an image with a transparent display device that includes a first polarization filter and a light polarization layer and that is configured to operate in conjunction with a second polarization filter. The method may comprise determining an angle of polarization of the second polarization filter and adjusting an angle of polarization of the light polarization layer based at least in part on the determined angle of polarization of the second polarization filter to enable an image to be viewed with the transparent display device.

According to some examples, a machine readable non-transitory medium having stored therein instructions that, in response to execution by one or more processors, operatively enable a polarization angle control module to perform a method to display an image with a transparent display device that includes a first polarization filter and a light polarization layer and that is configured to operate in conjunction with a second polarization filter. The method may comprise determining an angle of polarization of the second polarization filter and adjusting an angle of polarization of the light polarization layer based at least in part on the determined angle of polarization of the second polarization filter to enable an image to be viewed with the transparent display device.

According to some examples, a transparent display may include a first polarization filter, a light polarization layer, and a polarization angle control module coupled to the transparent display. The polarization angle control module may be operatively enabled to determine an angle of polarization of the first polarization filter and a second polarization filter and may adjust an adjustable angle of polarization of the light polarization layer based at least in part on the determined angle of polarization of at least one of the first polarization filter and the second polarization filter such that content displayed on the transparent display may be viewed with the transparent display.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will he described with additional specificity and detail through use of the accompanying drawings.

In the drawings:

FIG. 1 illustrates an example of a secure transparent display;

FIG. 2 illustrates an example of a secure transparent display;

FIG. 3 illustrates an example of a secure transparent display;

FIG. 4 illustrates a flow diagram of an example process to securely display an image on a transparent display;

FIG. 5 illustrates an example computer program product to securely display an image on a transparent display; and

FIG. 6 illustrates a block diagram of an example computing device, all arranged in accordance with at least some embodiments described herein.

### DETAILED DESCRIPTION

The following description sets forth various examples along with specific details to provide a thorough understanding of claimed subject matter. The subject matter may be practiced without some or more of the specific details disclosed herein. Further, in some circumstances, well-known methods, procedures, systems, components and/or circuits have not been described in detail, in order to avoid unnecessarily obscuring the subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the Figures, can be arranged, substituted, combined, and designed in a wide variety of different configurations, all of which are explicitly contemplated and made part of this disclosure.

This disclosure is drawn, inter alia, to technologies including methods, devices, systems, and computer readable media related to a secure transparent display that includes a first polarization filter and a light polarization layer, and that operates in conjunction with a second polarization filter. In one example, a polarization angle control module may determine an angle of polarization of the second polarization filter and adjust an angle of polarization of the light polarization layer based at least in part on the determined angle of polarization of the second polarization filter so as to display an image such that the image may be visible if viewed through both the first polarization filter and the second polarization filter of the transparent display device.

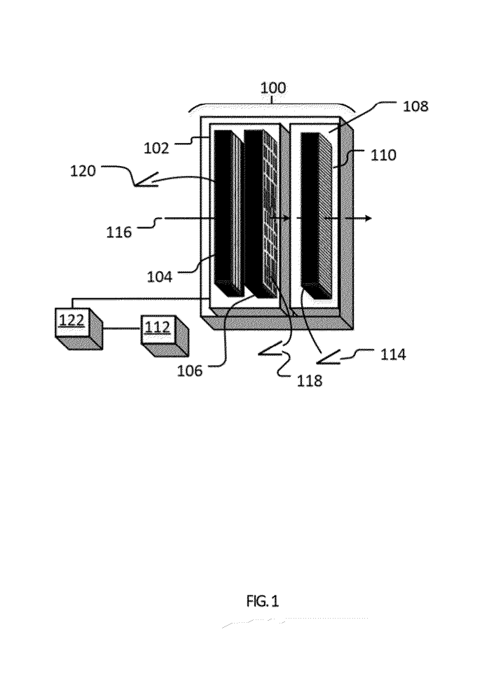

FIG. 1 illustrates an example of a secure transparent display 100, arranged in accordance with at least some embodiments. In an example, transparent display 100 may be a head-up display and may comprise a first screen 102 including a first polarization filter 104 and an adjustable light polarization layer 106. First polarization filter 104 may be configured to polarize light 116 at a first polarization angle 120, for example, in a vertical direction. In another example, first polarization filter 104 may polarize light 116 in a horizontal direction and/or any other direction. Adjustable light polarization layer 106 may comprise a liquid crystal display panel and may be configured to change a polarization angle for light 116 after it passes through first polarization filter 104. Adjustable light polarization layer 106 may comprise any of a variety of liquid crystal display technologies, for example, passive-matrix, active-matrix, twisted nematic super twisted nematic, in-plane switching, super in-plane switching, fringe field switching, advanced fringe field switching, vertical alignment, blue phase mode, and/or others or any combinations thereof.

In an example, transparent display 100 may comprise a second screen 108 including a second polarization filter 110. Second polarization filter 110 may be configured to polarize light 116 at a second polarization angle 114, for example, in a horizontal direction. In another example, second polarization filter 110 may polarize light 116 in a vertical direction and/or any other direction. First screen 102 and second screen 108 may be separate such that an orientation of second screen 108 may change with respect to first screen 102.

In an example, transparent display 10 may comprise a polarization angle control module 112 coupled to a processor 122 configured to control the display of an image and/or text or other content on transparent display 100. In another example, polarization angle control module 112 may be coupled directly to first screen 102. Polarization angle control module 112 may be configured to determine the second polarization angle 114 of second polarization filter 110 and may be configured to adjust a third polarization angle 118 of adjustable light polarization layer 106 based at least in part on the determined second polarization angle 114.

In a example, third polarization angle 118 may be adjusted such that an image displayed on adjustable light poolarization layer 106 may be visible when looking through first screen 102 and second screen 108 simultaneously and invisible when looking through first screen 102 alone. In an example, first polarization filter 104, adjustable light polarization layer 106, and/or second polarization filter 110 may be separate or may be disposed together or in any combination. For example, first polarization filter 104 and adjustable light polarization layer 106 may be embedded in one or more of: a windshield of an automobile, a computer display screen, goggles, a window, eyeglasses, a television display screen, a billboard, a marquee, a movie screen, clear dry erase board and/or other applications/implementations whereas second polarization filter 110 may be embedded in one or more wearable lenses (e.g., a pair of glasses and/or contact lenses). Thus, transpartent display 100 may be visible to a user wearing lenses including second screen 108 and invisible to all other viewers.

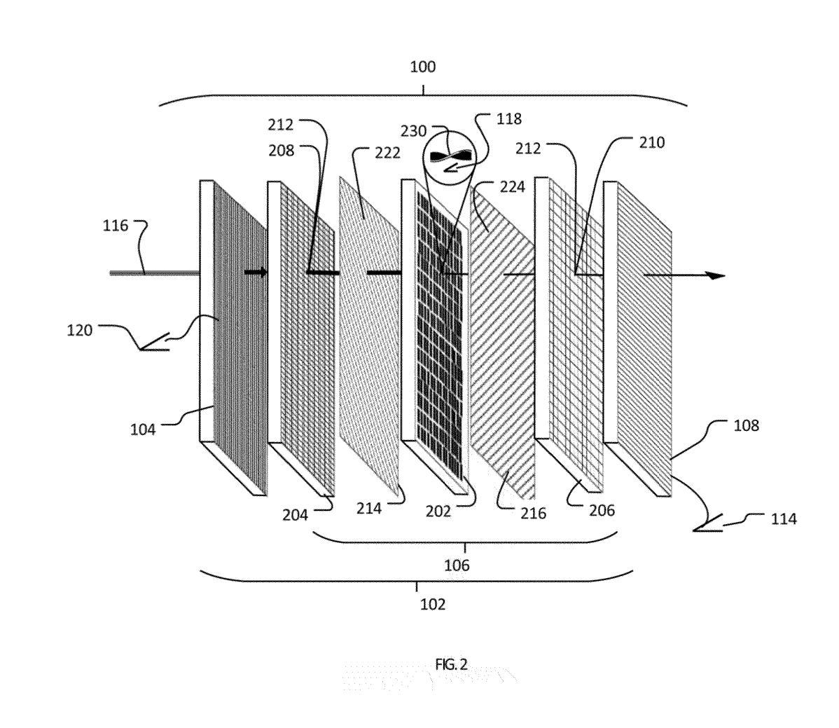

FIG. 2 is an exploded view of an example of secure transparent display 100, arranged in accordance with at least some embodiments. Secure transparent display 100 may comprise first screen 102 including first polarization filter 104 and adjustable light polarization layer 106. Adjustable light polarization layer 106 may comprise a plurality of pixels, for example, pixel 212. Adjustable light polarization layer 106 may include a liquid crystal layer 202 disposed between first glass layer 204 and a second glass layer 206.

In an example, liquid crystal molecules of liquid crystal layer 202 may be aligned with a first alignment layer 214 and a second alignment layer 216. First alignment layer 214 and second alignment layer 216 may each comprise grooves configured to align the liquid crystal molecules. First alignment layer 214 may form a part of first glass layer 204 or may be separate from first glass layer 204. Second alignment layer 216 may form a part of second glass layer 206 or may be separate from second glass layer 206. In an example, first grooves of first alignment layer may be etched into an outside surface of first glass layer and second grooves of second alignment layer may be etched into an outside surface of second glass layer.

In an example, first grooves of first alignment layer 214 may be oriented in a different direction than second grooves of second alignment layer 216. First alignment layer 214 and second alignment layer 216 may be configured to arrange liquid crystal molecules to rotate in a helix having a twist. A degree of twist may be determined by an orientation of first grooves 222 of first alignment layer 214 and second grooves 224 of second alignment layer 216 with respect to one another. Liquid crystal molecules may be configured to rotate in a helix having a twist of greater than 90%. In an example, liquid crystal layer 202 may be configured to rotate light between approximately −90° up to approximately +90° and/or approximately 0° up to approximately 180°. In another example, liquid crystal layer 202 may rotate light 116 up to approximately 270°.

In an example, first glass layer 204 may comprise a plurality of electrodes, for example, an electrode 208. Second glass layer 206 may comprise a plurality of electrodes, for example, an electrode 210 configured to correspond to electrode 208. Electrodes 208 and 210 may be transparent. In an example, electrodes 208 and 210 may be disposed in pixel 212.

In an example, a helical arrangement 230 of liquid crystal molecules of liquid crystal layer 202 may he adjusted by applying various voltages across electrodes 208 and 210 to change the helical arrangement 230 of liquid crystal molecules of liquid crystal layer 202. A degree of rotation of helical arrangement 230 of liquid crystal molecules of liquid crystal layer 202 may he inversely proportional or otherwise inversely related to an applied voltage. For example, if no electrical field is applied, liquid crystal molecules may be fully aligned with alignment layers 214 and 216 and may be fully rotated. If an electric field is applied to liquid crystal molecules of liquid crystal layer 202, liquid crystal molecules of liquid crystal layer 202 may align with the applied electrical field causing the helical arrangement 230 to untwist which may change third polarization angle 118. An orientation of light 116 passing through liquid crystal layer 202 may change as the helical arrangement 230 of liquid crystal molecules of liquid crystal layer 202 changes based on the applied voltage.

In an example, an amount of light 116 that is re-oriented after passing through first filter 104 such that it may pass through second polarization filter 110 may depend on at least one or more of: a voltage supplied, first polarization angle 120, second polarization angle 114, third polarization angle 118, and/or an orientation of the grooves of first alignment layer 214 and the grooves of second alignment layer 216 with respect to one another. Thus, an amount of opacity or transparency of pixel 212 may depend at least on these factors and/or other factor(s),

In an example, first polarization filter 104 may be a vertical filter and second polarization filter 110 may be a horizontal filter. When light 116 passes through first polarization filter 104 the vertical element of light 116 may remain. Liquid crystal molecules of liquid crystal layer 202 may rotate an angle of light 116 passing through pixel 212 according to third polarization angle 118. Third polarization angle 118 of liquid crystal molecules of liquid crystal layer 202 may correspond to helical arrangement 230 of liquid crystal molecules of liquid crystal layer 202.

In an example, liquid crystal molecules of liquid crystal layer 202 may rotate light 116 horizontally to substantially match a second polarization angle 114 of second polarization filter 110. Light 116 may thus pass through second polarization filter 110. In such an example, pixel 212 may appear illuminated when viewed through first polarization filter 104 and second polarization filter 110 thus pixel 212 may be visible on secure transparent display 100.

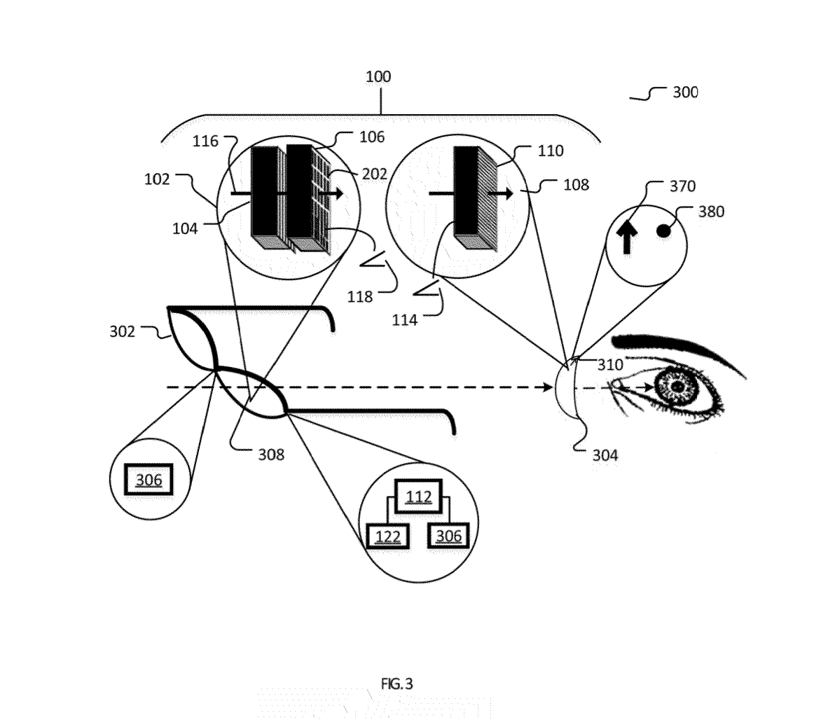

FIG. 3 illustrates an example of a secure transparent display system 300, arranged in accordance with at least some embodiments. System 300 may comprise a pair of glasses 302 and one or more contact lenses 304. In an example, a lens 308 of glasses 302 may comprise first screen 102 including a first polarization filter 104 and adjustable light polarization layer 106. In one example, adjustable light polarization layer 106 may comprise a plurality of pixels (see FIG. 2). Contact lens 304 may comprise second screen 108 including second polarization filter 110. In an example, because first screen 102 and second screen 108 are separate, an orientation of second screen 108 may change with respect to first screen 102.

In are example, glasses 302 r ay comprise polarization angle control module 112 coupled to processor 122. Glasses 302 may also comprise a sensor 306 coupled to either or both of polarization angle control module 112 and processor 122. Sensor 306 may be a plurality of sensors. Sensor 306 may be configured to sense and/or capture position and/or orientation data corresponding to a position of contact lens 304 and/or glasses 302. In an example, sensor 306 may comprise, an absolute position sensor and/or a relative position sensor (e.g., a displacement sensor). Position and/or orientation data may be communicated to polarization angle control module 112 and/or processor 122 to be analyzed to determine second polarization angle 114 of second polarization filter 110.

In an example, sensor 306 may be coupled to or in communication with a level 350 and may communicate level data to polarization angle control module 112. Level 350 may be coupled to the polarization angle control module 112. Level 350 may be configured to communicate level data to polarization angle control module 112 directly or via sensor 306. Polarization angle control module 112 may be operatively enabled to determine a first polarization angle 120 of first polarization filter 104 and a second polarization angle 114 of second polarization filter 110 based at least in part on the level data.

In an example, polarization angle control module 112 may be coupled to sensor 306 and first screen 102. Polarization angle control module 112 may be configured to receive sensor data from sensor 306. Polarization angle control module 112 and may derive a position and/or orientation of second polarization filter 110 based on the sensor data. Polarization angle control module 112 may determine second polarization angle 114 of second polarization filter 110 based on sensor data and/or the determined position and/or orientation second polarization filter 110 by a variety of methods. Polarization angle control module 112 may be configured to modify third polarization angle 118 of adjustable light polarization layer 106 based on the determined second polarization angle 114.

ire one example, sensor 306 may be a camera configured to capture an image of some portion of contact lens 304. In another example, sensor 306 may be any of a variety of sensing instruments configured to detect position in reference to a fixed point and/or arbitrary reference. Sensor 306 may be a linear, angular, and/or multi-axis sensor. Contact lens 304 may include a mark 310. Mark 310 may be, for example, an arrow, a dot, a solid or perforated line, a hollow or solid circle, and/or sonic other type of mark, or any combinations thereof. Mark 310 may be visible or invisible, an impression, an embossing, and/or the other mark, or any combinations thereof. Mark 310 may comprise any of a variety of compounds, for example ink, a metal, a reflective compound, and/or other material, or any combinations thereof. Mark 310 may have a particular orientation. For example, mark 310 may be linear and may be oriented at a particular angle and/or may have a top and bottom. In an example, sensor 306 may continuously track second polarization angle 114 based at least in part on the position and/or orientation of mark 310.

In an example, mark 310 may be an arrow 370 having a direction associated with second polarization angle 114 of second polarization filter 110. Sensor 306 may be a camera and may be configured to capture an image of contact lens 304 including arrow 370. Sensor 306 may communicate image data associated with the image to polarization angle control module 112 which may be configured to identify and analyze arrow 370 from the image data to determine a direction and/or orientation of arrow 370. Polarization angle control module 112 may be configured to determine second polarization angle 114 based at least in part on the image data.

In another example, mark 310 may comprise dot 380. During contact lens 304 manufacturing, contact lens 304 may be produced including dot 380 at 0 degrees or at a twelve o'clock position. Second polarization angle 114 may be added or applied to contact lens 304 such that it is perpendicular to a plane extending from dot 380. If contact lens 340 is worn, the lens may be continuously rotating its position on a user's eye. Polarization angle control module 112 may be configured to continuously track dots 380 to continuously monitor second polarization angle 114. For example, polarization angle control module 112 may be configured to capture one or more images of contact lens 304, identify dot 380, analyze an angle of rotation of contact lens 304 based at least in part on a position and/or orientation of dot 380, and determine second polarization angle 114 based at least in part on the determined angle of rotation of contact lens 304. In an example, if dot 380 is detected at a three o'clock position, then a second polarization angle 114 may be determined to be horizontal. Such determination of second polarization angle 114 may occur on a continuous and/or real time basis, periodically, irregularly, randomly, repeatedly, and/or may be manually triggered. As noted above, polarization angle control module 112 may be configured to modify third polarization angle 118 of adjustable light polarization layer 106 based on the determined second polarization angle 114.

In one example, polarization angle control module 112 may adjust third polarization angle 118 by varying an applied voltage to liquid crystal layer 202 based on the determined second polarization angle 114 such that an image displaying on adjustable light polarization layer 106 may he visible to a user when looking through first screen 102 and second screen 108 simultaneously.

In one example, third polarization angle 118 may be adjusted between approximately −90° up to approximately +−90° (or, approximately 0° up to approximately 180°). For example, if first polarization filter 104 is vertical (approximately 0°) and second polarization angle 114 is identified to be approximately 30°, one or more pixels of adjustable light polarization layer 106 may be controlled to modify a degree of transparency of the one or more pixels in order to display an image on secure transparent display 100. Although, transparency of the one or more pixels may be of varying degrees between opaque and transparent, for simplicity, only two states, opaque and transparent, are described herein. In order to render one or more pixels opaque, polarization angle control module 112 may substantially prevent polarized light from passing through second polarization filter 110 of contact lens 304 by adjusting third polarization angle 118 to approximately −60°. Whereas, in order to render one or more pixels transparent, polarization angle control module 112 may allow polarized light to pass through second polarization filter 110 of contact lens 304 by adjusting third polarization angle 118 to approximately 3020 . In another example, if second polarization angle 114 is identified to be approximately 15°, in order to render one or more pixels opaque, polarization angle control module 112 may substantially prevent polarized light from passing through second polarization filter 110 of contact lens 304 by adjusting third polarization angle 118 to approximately −75°. Whereas, in order to render one or more pixels transparent, polarization angle control module 112 may allow polarized light to pass through second polarization filter 110 of contact lens 304 by adjusting third polarization angle 118 to approximately 15°. Thus, by controlling a voltage applied liquid crystal layer 202, polarization angle control module 112 may adjust third polarization angle 118 of adjustable light polarization layer 106 to be any angle, for example, perpendicular or horizontal to the determined second polarization angle 114 of second polarization filter 110.

In an example, polarization angle control module 112 may adjust third polarization angle 118 for a plurality of pixels of adjustable light polarization layer 106 simultaneously. One or more of the plurality of pixels may be adjusted to polarization angles that are different from third polarization angle 118 in order to vary opacity of different pixels and to display an image on secure transparent display 100 properly.

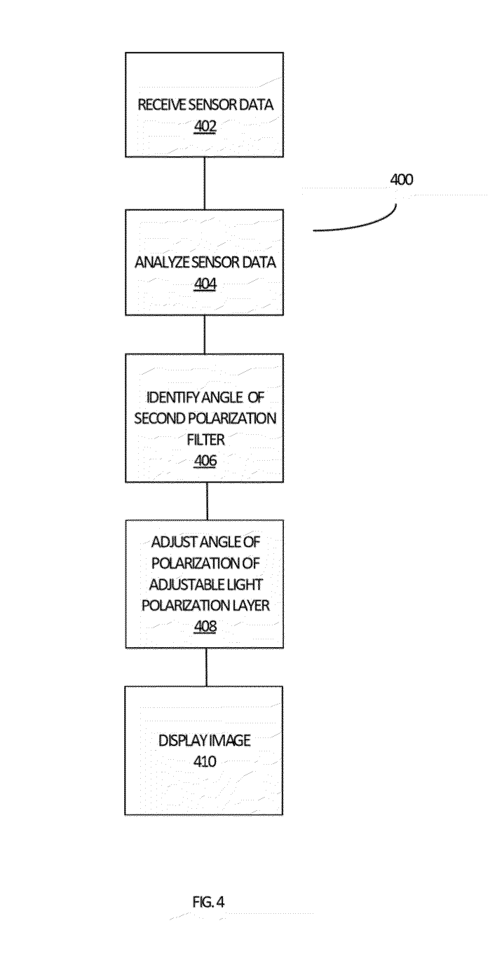

FIG. 4 is a flow diagram illustrating an example of a process 400 that may be utilized to securely display an image on a transparent display device, arranged in accordance with at least some embodiments described herein. FIG. 4 employs block diagrams to illustrate the example method(s) detailed therein. These block diagrams may set out various functional blocks or actions that may be described as processing steps, functional operations, events and/or acts, etc., and may be performed by hardware, software, firmware, and/or combination thereof, and need not necessarily be performed in the exact order shown. Numerous alternatives or additions to the functional blocks detailed (and/or combinations thereof) may be practiced in various implementations. For example, intervening actions not shown in FIG. 4 and/or additional actions not shown in FIG. 4 may be employed and/or some of the actions shown in the figures may be eliminated. In some examples, the actions shown in FIG. 4 may be operated using techniques discussed with respect to another figure. Additionally, in some examples, the actions shown FIG. 4 may be operated using parallel techniques. The above described and other rearrangements, substitutions, changes, modifications, etc., may be made without departing from the scope of the subject matter.

A transparent display device (such as transparent display 100 et seq. previously described above) for process 400 may include a sensor 306, a polarization angle control module 112, processor 122, a first polarization filter 104 and an adjustable light polarization layer 106, and may operate in conjunction with a second polarization filter 110. As depicted, process 400 may start at operation 402, where polarization angle control module 112 and/or processor 122 may receive orientation and/or position data from sensor 306. In an example, the position data may comprise sensor data including an image of a mark 310 on second polarization filter 110 and/or other position/orientation data. Process 400 may proceed to operation 404 where polarization angle control module 112 and/or processor 122 may analyze orientation and/or position data. Process 400 may move to operation 406 where polarization angle control module 112 and/or processor 122 may determine second polarization angle 114 of the second polarization filter 110 based on the analysis. Process 400 may proceed to operation 408 where polarization angle control module 112 and/or processor 122 may adjust one or more pixels 212 of adjustable light polarization layer 106 having third polarization angle 118 based on the determined first polarization angle 120 of first polarization filter 104 and/or second polarization angle 114 of second polarization filter 110. Process 400 may proceed to operation 410 where polarization angle control module 112 and/or processor 122 may make an image viewable on a transparent display device 100, responsive to adjusting third polarization angle 118 of the one or more pixels 212 of adjustable light polarization layer 106. In an example, polarization angle control module 112 and/or processor 122 may cause a voltage to be applied to one or more pixels of the light polarization layer 106 to change an orientation of liquid crystal molecules in a helical structure within adjustable light polarization layer 106. Adjusting third polarization angle 118 of adjustable light polarization layer 106 may alter an opacity of one or more pixels 212 of adjustable light polarization layer 106 such that an image may be viewed when looking through the transparent display device 100.

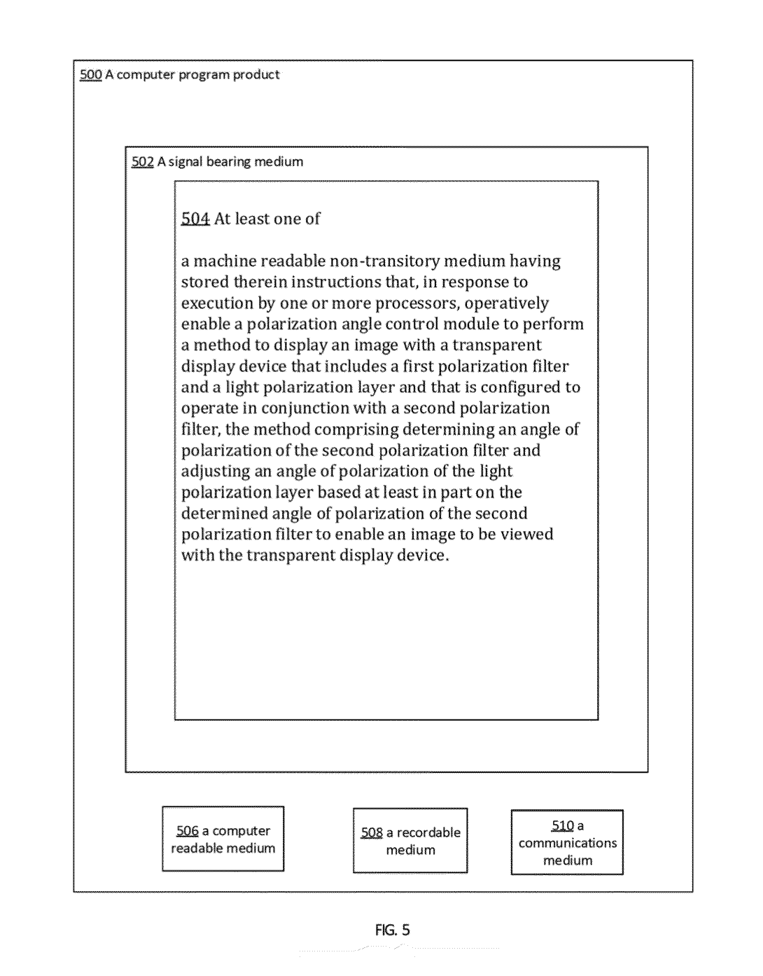

FIG. 5 is a block diagram illustrating one example of a computer program product 500, arranged in accordance with at least some embodiments described herein. As depicted, computer program product 500 a machine readable non-transitory medium having stored therein instructions that, in response to execution by one or more processors, operatively enable a polarization angle control module to perform a method to display an image with a transparent display device that includes a first polarization filter and a light polarization layer and that is configured to operate in conjunction with a second polarization filter. Computer program product 500 may include a signal bearing medium 502. Signal hearing medium 502 may include one or more machine-readable instructions 504, which, when executed by one or more processors, may operatively enable a computing device to provide the functionality described herein. In various examples, the devices discussed herein may use some or all of the machine-readable instructions.

In one example, the machine-readable instructions 504 may include, determining an angle of polarization of the second polarization filter. In some examples, the machine-readable instructions 504 may include and adjusting an angle of polarization of the light polarization layer based at least in part on the determined angle of polarization of the second polarization filter to enable an image to be viewed with the transparent display device.

In one example, signal bearing medium 502 may encompass a computer-readable medium 506, such as, but not limited to, a hard disk drive, a Compact Disc (CD), a Digital Versatile Disk (DVD), a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communication link, a wireless communication link, etc.). In some examples, signal hearing medium 502 may encompass a machine readable non-transitory medium.

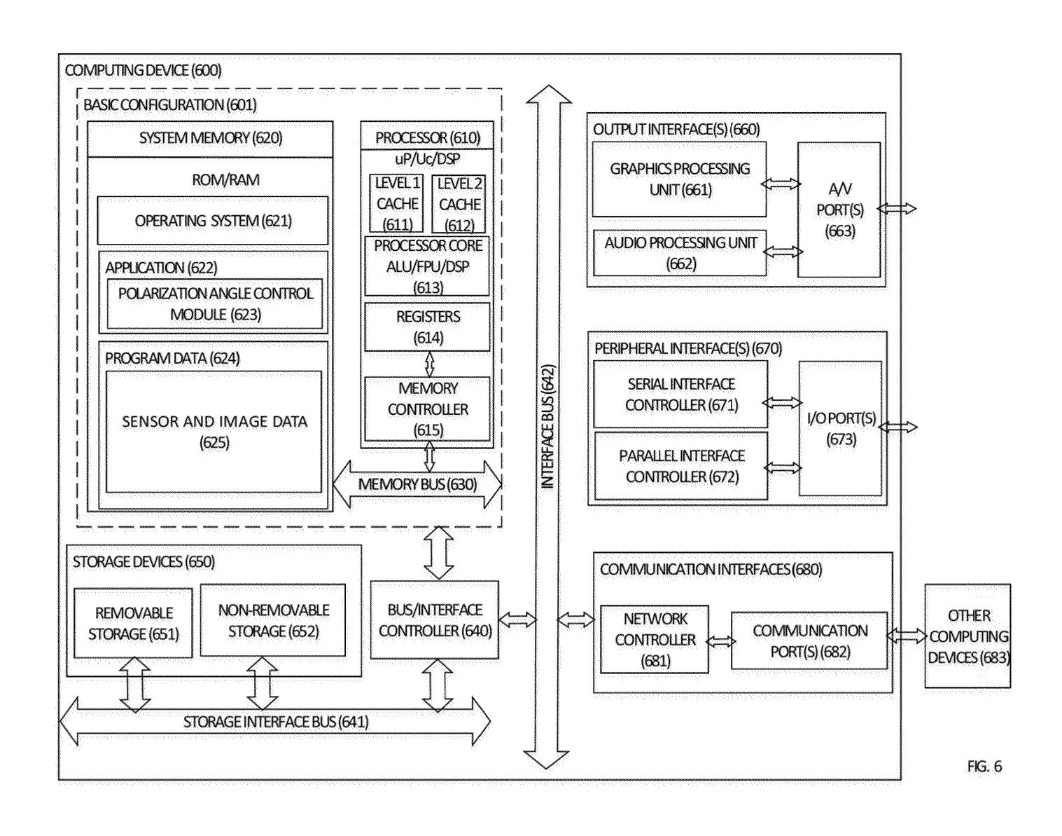

in general, the method described with respect to FIGS. 1-5, and elsewhere herein may be implemented in any suitable server and/or computing system. Example systems may be described with respect to FIG. 6 and elsewhere herein. In general, the computer system may be configured to determine an angle of polarization 114 of a second polarization filter 110 and adjust and an angle of polarization 118 of the light polarization layer 106 to display the image such that the image may be visible if viewed through the transparent display device 100.

FIG. 6 is a block diagram illustrating an example of a computing device 600, arranged in accordance with at least some embodiments of the present disclosure. In various examples, computing device 600 may be configured to facilitate detecting an angle of polarization of a remote (or non-remote) polarization filter and adjusting an angle of polarization of a local (or non-local) adjustable light polarization layer based on the detected angle to display an image on a transparent display when viewed through the remote polarization filter and the local polarization filter simultaneously as discussed herein. In one example of a basic configuration 601, computing device 600 may include one or more processors 610 and a system memory 620. A memory bus 630 can be used for communicating between one or more processors 610 and system memory 620.

Depending on the desired configuration, one or more processors 610 may be of any type including but not limited to a microprocessor (μP), a microcontroller (μC), a digital signal processor (DSP), or any combination thereof. One or more processors 610 may include one or more levels of caching, such as a level one cache 611 and a level two cache 612, a processor core 613, and registers 614. Processor core 613 can include an arithmetic logic unit (ALU), a floating point unit (FPU), a digital signal processing core (DSP Core), or any combination thereof. A memory controller 615 can also be used with one or more processors 610, or in some implementations memory controller 615 can be an internal part of processor 610.

Depending on the desired configuration, system memory 620 may be of any type including but not limited to volatile memory (such as RAM), non-volatile memory (such as ROM, flash memory, etc.) or any combination thereof. System memory 620 may include an operating system 621, one or more applications 622, and program data 624. One or more applications 622 may include a polarization angle control module application 623 that may be arranged to perform the functions, actions, and/or operations as described herein including the functional blocks, actions, and/or operations for may be configured to facilitate detecting an angle of polarization of a remote polarization filter and adjusting an angle of polarization of an adjustable local polarization layer based on the detected angle to display an image on a transparent display when viewed through the remote polarization filter and the local polarization filter simultaneously as described herein. Program data 624 may include, among other data, sensor data 625 or the like for use with polarization angle control module application 623, as described herein. In some example embodiments, one or more applications 622 may be arranged to operate with program data 624 on operating system 621. This described basic configuration 601 is illustrated in FIG. 6 by those components within dashed lines.

The computing device 600 may have additional features or functionality, and additional interfaces to facilitate communications between basic configuration 601 and any required devices and interfaces. For example, a bus/interface controller 640 may be used to facilitate communications between basic configuration 601 and one or more data storage devices 650 via a storage interface bus 641. One or more data storage devices 650 may be removable storage devices 651, non-removable storage devices 652, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data. System memory 620, removable storage 651 and non-removable storage 652 are all examples of computer storage media. The computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

The computing device 600 may also include an interface bus 642 for facilitating communication from various interface devices (e.g., output interfaces, peripheral interfaces, and communication interfaces) to basic configuration 601 via bus/interface controller 640. Example output interfaces 660 may include a graphics processing unit 661 and an audio processing unit 662, which may be configured to communicate to various external devices such as a display or speakers via one or more A/V ports 663. Example peripheral interfaces 670 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 683 over a network communication via one or more communication ports 682. A communication connection is one example of a communication media. Communication media may typically be embodied by computer readable instructions, data structures, program modules, or other data in a modulated data signal, such as a carrier wave or other transport mechanism, and may include any information delivery media, A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 600 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. In addition, computing device 600 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may he in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

The use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can he equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium Include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network complain/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to meal “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the hare recitation of two recitations, without other modifiers, typically means at least two recitations, or two or more recitations). Furthermore, in those instances where a convention analogous to “at least one of A, B, and C, etc. ” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an example,” “one example,” “some examples,” or “other examples” may mean that a particular feature, structure, or characteristic described in connection with one or more examples may be included in at least some examples, but not necessarily in all examples. The various appearances of “an example,” “one example,” or “some examples” in the preceding description are not necessarily all referring to the same example.

While certain exemplary techniques have been described and shown herein using various methods and systems, it should be understood by those skilled in the art that various other modifications may be made, and equivalents may be substituted, without departing from claimed subject matter. Additionally, many modifications may he made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A system comprising:
a first lens including a first polarization filter and a light polarization layer;
a second lens including a second polarization filter; and
a polarization angle control module coupled to the first lens, the polarization angle control module operatively enabled to:
determine an angle of polarization of the second polarization filter; and
adjust an angle of polarization of the light polarization layer based at least in part on the determined angle of polarization of the second polarization filter such that an image received by the first lens is visible to a viewer that uses both the first lens and the second lens and invisible to another viewer that uses only the first lens.

2. The system of claim 1, wherein the second lens includes a contact lens.

3. The system of claim 2, further comprising a camera coupled to the polarization angle control module, wherein the contact lens includes a mark and the polarization angle control module being, further operatively enabled to:
receive the image from the camera; and
identify a position of the mark based at least in part on the received image; and
wherein the polarization angle control module is operatively enabled to determine the angle of polarization of the second polarization filter based at least in part on the identified position of the mark.

4. The system of claim 3, wherein the mark includes an arrow.

5. The system of claim 1, wherein to adjust the angle of polarization of the light polarization layer, the polarization angle control module is operatively enabled to:
adjust the angle of polarization of the light polarization layer to be perpendicular or horizontal relative to the determined angle of polarization of the second polarization filter.

6. (canceled)

7. The system of claim 1, wherein the light polarization layer includes a plurality of pixels and the polarization angle control module is further operatively enabled to:
adjust an angle of polarization of one or more of the plurality of pixels of the light polarization layer to be perpendicular relative to the determined angle of polarization of the second polarization filter: and
adjust the angle of polarization of one or more of the plurality of pixels of the light polarization layer to be horizontal relative to the determined angle of polarization of the second polarization filter.

8. The system of claim 7, wherein the polarization angle control module is further operatively enabled to:
adjust the angle of polarization of one or more of the plurality of pixels of the light polarization layer to be more than horizontal but less than perpendicular relative to the determined angle of polarization of the second polarization filter.

9. A method to display an image with a transparent display device that includes a first polarization filter and a light polarization layer and that is configured to operate in conjunction with a second polarization filter, the method comprising:
determining an angle of polarization of the second polarization filter, wherein the second polarization filter is incorporated into a contact lens; and
adjusting an angle of polarization of the light polarization layer based at least in part on the determined angle of polarization of the second polarization filter such that an image received by the transparent display device is visible to a viewer that uses the contact lens and invisible to another viewer that does not use the contact lens.

10. (canceled)

11. The method of claim 9, wherein the contact lens includes a mark and the method further comprises:
receiving the image through the contact lens; and
identifying a position of the mark based at least in part on the received image; and
wherein determining the angle of polarization of the second polarization filter includes determining, the angle of polarization of the second polarization filter based at least in part on the identified position of the mark.

12.-13. (canceled)

14. The method of claim 9, wherein adjusting the angle of polarization of the light polarization layer includes:
adjusting the angle of polarization of the light polarization layer to be perpendicular or horizontal relative to the determined angle of polarization of the second polarization filter.

15. The method of claim 9, wherein the light polarization layer includes a plurality of pixels and the method further comprises:
adjusting an angle of polarization of one or more of the plurality of pixels of the light polarization layer to be perpendicular relative to the determined angle of polarization of the second polarization filter; and
adjusting the angle of polarization of one or more of the plurality of pixels of the light polarization layer to be at least horizontal but less than perpendicular relative to the determined angle of polarization of the second polarization filter.

16. (canceled)

17. A machine readable non-transitory medium having stored therein instructions that, in response to execution by one or more processors, operatively enable a polarization angle control module to perform the method of claim 9.

18. An apparatus, comprising:
a transparent display including a first polarization filter and a light polarization layer configured to operate in conjunction with a second polarization filter; and
a polarization angle control module coupled to the transparent display, the polarization angle control module operatively enabled to:
determine an angle of polarization of the first polarization filter and a the second polarization filter, wherein the second polarization filter is incorporated into a lens; and
adjust an adjustable angle of polarization of the light polarization layer based at least in part on the determined angle of polarization of at least one of the first polarization filter and the second polarization filter such that content received by the transparent display is visible to a viewer that uses the lens and invisible to another viewer.

19. The apparatus of claim 18, further comprising a level coupled to the polarization angle control module, wherein the polarization angle control module is operatively enabled to determine the angle of polarization of the first polarization filter and the second polarization filter based at least in part on the level.

20.-21. (canceled)

22. The apparatus of claim 18, wherein the transparent display is formed in at least one of eyeglasses, goggles, a contact lens, a windshield, a computer screen, a window, a billboard, a marquee, a movie screen and a clear dry erase board.

23. The apparatus of claim 18, wherein the light polarization layer comprises:
a liquid crystal layer comprising liquid crystal molecules disposed between a first glass layer and a second glass layer, wherein the liquid crystal molecules are configured to adjust the adjustable angle of polarization of the light polarization layer to orient light to varying degrees of alignment with either or both of the first polarization filter or the second polarization filter;
a first alignment layer comprising first grooves; and
a second alignment layer comprising second grooves, wherein the liquid crystal molecules of the liquid crystal layer are aligned with the first grooves of the first alignment layer and the second grooves of the second alignment layer.

24. The apparatus of claim 23, wherein the first grooves are etched in a first outside surface of the first glass layer and the second groves are etched into a second outside surface of the second glass layer.

25. The apparatus of claim 23, wherein the first grooves of the first alignment layer are oriented in a different direction than the second grooves of the second alignment layer.

26. The apparatus of claim 23, wherein the first alignment layer and the second alignment layer are configured to arrange the liquid crystal molecules of the liquid crystal layer such that they rotate in a helix having a twist wherein a degree of the twist corresponds to an orientation of the first grooves and the second grooves with respect to one another.

27. The apparatus of claim 26, wherein the liquid crystal molecules are arranged to rotate greater than 90°.

28. The apparatus of claim 26, wherein the liquid molecules are arranged to rotate light between approximately −90° up to approximately +90° and/or between approximately 0° up to approximately 180°.

29. The apparatus of claim 26, wherein the liquid crystal molecules are arranged to rotate light up to approximately 270°.

30. The apparatus of claim 23, wherein the first glass layer comprises a first electrode and the second glass layer comprises a second electrode configured to correspond to the first electrode, wherein a helical arrangement of one or more of the liquid crystal molecules of the liquid crystal layer are adjusted by applying a voltage across the first electrode and the second electrode to change the helical arrangement.

31. The apparatus of claim 30, wherein a degree of rotation of the helical arrangement of the one or more of the liquid crystal molecules of the liquid crystal layer is inversely related to a strength of the applied voltage.

32. The apparatus of claim 31, wherein the degree of rotation of the helical arrangement of the one or more of the liquid crystal molecules of the liquid crystal layer corresponds to the adjustable angle of polarization of the light polarization layer, wherein the liquid crystal layer is configured to rotate light in proportion to the degree of rotation of the helical arrangement of the one or more of the liquid crystal molecules of the liquid crystal layer based on the applied voltage.

33. The apparatus of claim 18, wherein the content is displayed horizontally on the transparent display.
